(19) United States
(12) Patent Application Publication
(10) Pub. No.: US 2023/0334731 A1
(43) Pub. Date: Oct. 19, 2023

(54) METHOD AND DEVICE FOR CORRECTING COHERENCE TOMOGRAPHY IMAGES

(71) Applicant: ZUMBACH ELECTRONIC AG, Orpund (CH)

(72) Inventor: Silvano BALEMI, Tenero (CH)

(73) Assignee: ZUMBACH ELECTRONIC AG, Orpund (CH)

(21) Appl. No.: 17/917,271

(22) PCT Filed: Apr. 20, 2021
(86) PCT No.: PCT/EP2021/060260

§ 371 Date: Apr. 27, 2023

(30) Foreign Application Priority Data
Apr. 22, 2020 (EP) 20170895.5

(51) Int. Cl. G06T 11/00

(52) U.S. Cl. CPC G06T 11/008; G06T 2211/424

(57) ABSTRACT

Method for rectifying images of an elongated, preferably translucent, object generated by means of an optical coherence tomography method having the following steps: a capturing step, in which at least one region of the object is captured in at least one first orientation (γ1) in a first image and in at least one second, different, orientation (γ2) in a second image, preferably by an optical coherence tomography method; and a determination step, wherein corresponding reconstruction images (R1, R2) of the region are generated on the basis of the captured images, wherein at least one refractive index (n₁, n₂, n₃) is determined, preferably iteratively, for each of a plurality of layers of the object on the basis of spatial, reconstruction deviations (Δexy) between the first and second reconstruction images, a rectification step, wherein a rectified overall reconstruction image is calculated based on the determined refractive indices (n₁, n₂, n₃).

### FIELD OF THE INVENTION

The invention relates to a method for rectifying images of an elongated, in particular translucent, object, which are generated in particular by means of an optical coherence tomography method, a computer-readable medium, a device for rectifying images of an object, and a system.

### BACKGROUND OF THE INVENTION

In imaging systems, such as optical coherence tomography (OCT) systems, objects, in particular translucent and/or opaque elongated objects, can be (spatially) captured. Often, in optical coherence tomography, images of at least one (partial) region of the object to be captured (measured), a region-of-interest (ROI), are generated, for example, in that a broadband light signal with little coherence length is temporally (in an OCT method in the time domain, the time-domain, (TD-OCT) as well as in the frequency domain with the aid of a spectrometer, the frequency domain, (FT-OCT)) or an in the wavelength time-varying monochromatic light signal (in an OCT method in the frequency domain with a wavelength-controlled source, the swept source (SS-OCT)) is split in a beam splitter into at least two partial signals. A first partial signal (the radiation signal) is emitted onto a region of the object to be captured and a second partial signal (the reference signal) passes through a reference path.

The first partial signal (measuring signal) reflected by the object to be captured is superimposed with the reference signal in an interferometer, whereby an interference signal is generated. From the interference signal, the structure or the image of the captured object along the optical axis (i.e. the depth of the object) can be reconstructed.

In OCT images, for example, generated as simplified above, the ray paths within the object to be captured are imaged elongated due to a larger refractive index than that of air. In addition, the result of the measurement along the ray path appears straight in the OCT image, although in reality the ray path, due to refraction at different layer boundaries or layer transitions of the object with different refractive indices, experiences deflections in each case. The greater the differences in the refractive indices of the individual materials of the layers of the object in relation to the refractive index no of the air surrounding the object, the greater the effect of the elongated representation of the object to be imaged along the ray paths within the object and the more the actual ray path, depending on the angle of incidence, whose measured ray path is represented as straight in the OCT image, is deflected. Therefore, the object to be captured (or the partial region of the object to be captured) appears distorted in an OCT image.

In such OCT systems or OCT methods for measuring elongated objects, usually only a few discrete orientations are measured (for a given cross-section), for example only two orientations are captured or used for a given cross-section. It is therefore a form of discrete tomography and not a continuous tomography method with, for example, more than 100 or more than 1000 images (at different angles). At least in principle, the invention starts from such a discrete tomography method.

In the prior art, the refractive index of the material of the (measuring) object is or the refractive indices of the materials of different layers of the (measuring) object are not known a priori, whereby the OCT images always show a certain distortion.

In the prior art, fixed pre-estimated values are sometimes assumed for the refractive indices in order to rectify the OCT images. However, a priori estimates have so far proven to be too inaccurate, also because the refractive index can change due to time-dependent material properties (e.g. due to composition, temperature and density differences), whereby the reconstructed images of the object from the measured OCT images can still be subject to distortion.

Without an as precise as possible and regularly updated indication of the refractive indices, it is thus still not possible to reconstruct the object cross-section of objects to be measured in the measurement field with low distortion (or approximately distortion-free).

### SUMMARY OF THE INVENTION

The invention is therefore based on the object of reducing the above-mentioned disadvantages of the prior art and providing a method and a device which makes it possible to generate (in particular continuously) a low-distortion, preferably approximately distortion-free, reconstruction image of at least a partial region of a (measuring) object to be captured.

The object is solved in particular by a method according to the present invention for rectifying (or the deskewing) of images of an elongated object, which are generated in particular by means of an optical coherence tomography method.

In particular, the object is solved by a (computer-implemented) method for rectifying images of an, in particular elongated, preferably translucent, object, which are generated in particular by means of an optical coherence tomography method, wherein the method comprises the following steps:
a) a capturing step in which at least one region of the object is captured in at least one first orientation in a first image and in at least one second, in particular different, orientation in a second image, preferably by means of an optical coherence tomography method; as well as
b) a determination step, wherein reconstruction images of the region are generated on the basis of the captured images, wherein at least one refractive index is determined, preferably iteratively, for each of a plurality of layers of the object on the basis of, in particular spatial, reconstruction deviations between the first and second reconstruction images; as well as
c) a rectification step, wherein a rectified overall reconstruction image is calculated based on the determined refractive indices.

A core idea of the invention is based on the fact that by determining the refractive indices of the individual layers of an object—for example at least one refractive index for each layer—it is possible to calculate a rectified overall reconstruction image of an object captured, for example by an OCT method.

The optical coherence tomography method may comprise the emission and reception or capturing of light, in particular infrared light.

For the determination of the refractive indices of the individual layers of an object, at least one region of the object is first captured from multiple (different) orientations. Corresponding reconstruction images are generated from the images in which the region of the object has been captured from several (different) orientations. Subsequently, the (spatial) reconstruction deviations present between the corresponding reconstruction images are calculated, and with the calculated reconstruction deviations at least one refractive index for each layer of the plurality of layers that the object may have, can be determined for which the reconstruction deviations are minimal. This determined refractive index corresponds at least substantially to the actual refractive index of the material of the respective layer.

By an orientation is meant in particular a direction or angle at which the (elongated) object is captured (by means of a capturing device). In particular, an orientation can thus be changed (or varied) by rotating the object to be measured and/or by changing the orientation of a capturing device and/or by arranging several capturing devices at different angles.

As already explained above in connection with the prior art, the invention starts from in particular discrete tomography methods known per se, in which only a few orientations (e.g. 2, 3, 4, 5, or more, but in particular 20 or less, or 10 or less, or five or less) orientations are measured, and not from continuous tomography methods known (in a different technical context) with possibly 100 or even 1000 individual images. Insofar as several orientations are used in the present context, this has in particular the purpose of capturing or measuring a larger angular region (or region of the cross-section to be captured).

On the basis of the refractive indices of the individual layers of an object determined as described above, a low-distortion or (approximately) distortion-free overall reconstruction image can be calculated, whereby the thus rectified overall reconstruction image can be, for example, a cross-sectional image of an object to be captured.

As soon as the refractive indices of the individual layers of the object have been determined, distortion-free reconstruction images can now be calculated on the basis of the determined refractive indices, for example for further, similar objects or further cross-sections of the same object, whereby the object may now only be captured from one orientations.

A reconstruction image (reconstruction) can preferably be understood as a two- or three-dimensional image of the captured object or at least of a region of the object, in which possible distortions have been corrected under assumptions of various parameters or variables. The two- or three-dimensional image (reconstruction) can have the actual dimensions of the captured object. By a two-dimensional reconstruction image can be understood in particular a cross-sectional image of the object to be captured. Preferably, a three-dimensional reconstruction image can be understood as a corresponding sequence of several cross-sectional images (e.g. at least or exactly two, or at least or exactly three, or at least or exactly four, and/or at most 16 or at most 8).

The object to be captured is preferably an elongated and/or translucent and/or opaque object, which may have several layers, which may possibly have different materials with possibly different refractive indices. Such an object can be formed, for example, by: a single-layer or multi-layer (plastic) film or a single-layer or multi-layer (plastic) tube or a single-layer or multi-layer (plastic) hose.

In a specific example, the elongated object may be a cable, in particular a fibre optic cable or a wire (sheathed with plastic insulation), or also catheters, such as multilumen catheters.

The elongated object is preferably at least 5 times, in particular at least 50 times, possibly at least 100 times and/or at most 10,000 times as long as it is wide (the width being understood to mean a diameter or maximum diameter in a given cross-section; if this width varies over the length of the object, an arithmetic mean is preferably to be used, preferably in relation to equidistant cross-sections which have a spacing of at most or exactly 1/100 of the length). Where appropriate, the width of the elongated object is (at least substantially) constant.

The elongated object may (at least in sections, viewed over the length, for example over at least 50% of the length) be at least substantially oval (optionally elliptical or circular). The elongated object may be hollow inside at least in sections (seen over the length) or non-hollow (at least in sections) or both hollow (for example in a first section) as well as non-hollow (in a further section). In embodiments, the cross-section of the elongated object may be annular (at least in sections) along its length.

The elongated object may be flexible or (at least substantially) rigid.

A width of the elongated object (in case of variable width, preferably on average) may be at least 0.1 mm or at least 1 mm and/or at most 20 mm or at most 10 mm.

A length of the elongated object may be at least 10 mm or at least 100 mm or at least 1000 mm and/or at most 10 m.

For example, if the elongated object is flexible, it can be rolled (at a temperature of 20° C.) onto a cylinder with a diameter of 1 m (without breaking or otherwise being damaged). If the elongated is (at least substantially) rigid, this should preferably not be possible.

In particular, it is assumed that the refractive indices of the materials within the respective layer or the respective region (ROI) are at least substantially constant.

Preferably, a reconstruction deviation may include local deviations for an area or a region (ROI) of the object or an overall reconstruction deviation for all available images if it is assumed that the refractive index of a layer is the same everywhere.

For the determination of the overall reconstruction image from the different OCT images, the refractive index of the material of the object or, if applicable, the refractive indices of the materials of the individual layers of the object can be determined, whereby the object, at least in a (partial) region, is (approximately) simultaneously and/or at least overlappingly captured or measured. The capturing can take place, for example, according to an OCT method from several orientations or directions.

In a preferred embodiment, the capturing step and the determining step are each done periodically repeatedly or event-controlled, wherein preferably an execution rate of the capturing step differs from an execution rate of the determining step, provided that both steps are done periodically repeatedly, whereby an estimate of the at least one refractive index of the layers of the object can be updated again and again. It is thus possible to determine the at least one refractive index of the layers of the object (at least approximately) continuously. Furthermore, processes are also conceivable in which a periodic execution of the capturing step and the determination step is carried out in an event-controlled manner for a predetermined duration or a predetermined number of repetitions. Preferably, the (refractive index) determination step takes place in parallel with the rectification step (reconstruction step) and/or capturing step, in two parallel software processes: The determination step slower, e.g. at 1 Hz, the rectification step (reconstruction step) and/or the capturing step faster e.g. at 100 Hz.

Generally, a frequency of the capturing step and/or the rectification step may be at least 2 times or at least 5 times or even at least 20 times as large as a frequency of the (refractive index) determination step.

Preferably, the frequencies of the capturing step and the rectification step are equal or at least approximately equal (so that, for example, the frequency of the capturing step is at least 0.75 times and at most 1.25 times as large as the frequency of the rectification step).

The (respective) frequency may be constant or fluctuate during the measurement of the respective elongated object. If the frequency fluctuates, a corresponding average value (sum of the measurement processes divided by total measurement duration for a particular elongated object) shall be used to compare the respective frequencies with each other.

Alternatively or additionally, for at least one time section of the entire measurement of the object, more capturing and/or rectification steps are performed than (refractive index) determination steps.

In embodiments, the elongated object is moved along at least in sections between two capturing steps (for example continuously and/or at a constant speed, possibly also in discrete steps) such that the cross-section of the elongated object can be captured at different points by the multiple capturing steps. For example, when measuring a cable, this can be captured (possibly during a manufacturing process or also afterwards, for example by unwinding from a coiled state) at various points with regard to its cross-section. In particular, in such a context, for example, a periodic repetition of the capturing step is advantageous, for example with a frequency of at least 0.1 Hertz, possibly at least 1 Hertz and/or at most 100 Hertz.

An event-driven execution of the respective step may be useful, for example, if it is determined on the basis of other measurements or other input that (for example, in the case of a continuous cable or the like) a change is to be expected.

Preferably, the determination step is performed less frequently than the capturing step (and/or rectification step), taking advantage of the fact that it is to be assumed with comparatively high probability that the refractive indices captured in a particular run of the determination step remain the same, for example, at another cross-section of the elongated object, while the geometry of the elongated object may change. Overall, this can save computational effort in a particularly effective manner.

In general, it is preferred if the capturing step (and/or rectification step) is carried out on at least 2 or at least 4 or at least 10 or at least 20 and/or at most 1000 different cross-sections of the elongated object (viewed over the length of the elongated object) in order to capture or check the object with respect to a cross-section along its length.

Alternatively or additionally, it is conceivable that the determined refractive indices are stored in a data structure, wherein the stored refractive indices of the individual layers of the object can serve as initial values when the determination step is performed again for, for example, further regions of the object or further objects.

Preferably, for each of the layers of the object the at least one refractive index is determined using an optimisation method, in particular by minimising an objective function calculated from the, preferably spatial, reconstruction deviations. In this way, at least one refractive index, which minimises the reconstruction deviations between the corresponding reconstruction images, can be determined or estimated in a comparatively computationally efficient manner.

In one embodiment, the objective function calculated from the, preferably spatial, reconstruction deviations is a multi-dimensional objective function. For the multi-dimensional objective function, the optimisation method can (directly) determine a set of refractive indices for the layers of the object that minimises the multi-dimensional objective function. By that the more complex optimisation problem can be solved directly, whereby a successive (layer-by-layer) approach can be avoided.

Preferably, the at least one refractive index of the first layer adjacent to a surface of the object is first determined using an optimisation method, since the refractive index of the medium surrounding the object to be captured is known a priori (sufficiently).

It is preferred that the at least one refractive index, starting from the first layer, is successively determined for each further layer, which in particular adjoins the first layer or a respective preceding layer, using an optimisation method. In this way, the optimisation method can be carried out successively for each individual layer, whereby the estimates of the refractive indices of the individual layers can be determined particularly precisely. In particular, the result for the determination of the refractive index or the refractive indices of the respective deeper layer of the object is dependent on the result for the previous (closer to the surface of the object) layer.

In particular, the spatial reconstruction deviations are calculated by determining the spatial distances between a plurality of points of an interface of a layer, the positions of which are calculated on the basis of the first reconstruction image, with a plurality of points of the interface of the layer, the positions of which are calculated on the basis of the second reconstruction image and/or at least one further reconstruction image, preferably all (existing) reconstruction images, wherein the objective function is calculated in particular as the sum of the spatial distances. In particular, the spatial distances can be understood as any (weighted) norm describing a deviation of at least two points. Preferably, the objective function is calculated as the sum of the squares of the spatial distances. In particular, hereby the smallest (spatial) distances of a point with all reconstructed points from another reconstructed image (further reconstruction image) are determined and summed up. In this way, a (spatial) distance to each of the further reconstruction images can be calculated for each point.

In this way, an objective function, by means of which at least one refractive index can be determined at which the spatial reconstruction deviations of the corresponding reconstruction images, which are based on images taken from different orientations or directions, are minimised, can be obtained in a simple manner.

Preferably, the at least one refractive index that minimises the objective function for each of the layers is determined using a raster search method. With the raster search method, which is characterised in particular by the fact that it can converge to an (at least approximately) optimal result in a comparatively short time even with low demands on the required algorithms, the objective function can be minimised in a comparatively simple manner.

In one embodiment, the at least one refractive index for each of the layers is determined using a random search method, whereby a refractive index is selected from a set of previously and/or continuously set refractive indices in such a way that the objective function is minimised. On the one hand, by this the solution space of the optimisation method is further restricted, whereby the required computing power and the time required for the optimisation method to converge can be reduced. On the other hand, by this also global optima for the at least one refractive index in the objective function can be determined.

It is preferred that the at least one refractive index for each of the layers that minimises the objective function is determined with a gradient method, whereby a particularly precise result is determined for the determined at least one refractive index that represents an (at least local) optimum (minimum) in the objective function.

Gradient methods can be understood here as optimisation methods in which at least one parameter (at least one refractive index) and/or parameter set that minimises the objective function is searched for and determined iteratively (step-by-step). The direction used in each step of this method is obtained in particular by the (possibly negative) direction of the gradient (of the first derivative of the objective function) in the current parameter point of the current step (steepest-descent method). Furthermore, other, sometimes more complex, gradient-based methods are also possible, such as the Newton method, in which, in addition to the first derivative of the objective function, the second derivative of the objective function is also used for the determination of the direction in the current parameter point of the current step.

Of course, other optimisation methods as known in numerical mathematics are conceivable.

In a further embodiment, in the capturing step, the region is captured in a plurality of further, in particular different, orientations in a plurality of further images.

In particular, in the determining step, a plurality of corresponding reconstruction images of the region(s) is generated on the basis of the captured plurality of further images, and the refractive indices are determined on the basis of, in particular spatial, reconstruction deviations between/among the plurality of corresponding reconstruction images, preferably iteratively.

In particular, by this the effects of noise effects that may be present in the reconstruction images can be further reduced. Furthermore, for example, further measurement inaccuracies as well as non-linearities or sampling errors can be taken into account and reduced.

In a further embodiment, the capturing step is performed for one or a plurality of further regions of the object, which, in particular, overlap at least partially with each other, wherein each of the further regions of the object is captured from at least two different orientations or directions, and wherein in the determining step, for each region of the object captured from at least two orientations, the refractive indices of the materials of the layers of the object are determined.

Preferably, by this several regions of the object can be grouped together so that redundant information for determining the refractive index or the refractive indices (for example for a plurality of layers of the object) is available from which a set of (iteratively) determined refractive indices (for example for a plurality of layers of the object) can be determined. With the set of refractive indices (subsequently) a rectified (overall) reconstruction image can be calculated.

For example, in the case of objects of which several regions are also captured from several, different orientations, it may, however, occur that it is not possible, for example due to the shape of the object and/or due to the arrangement of the object and the capture unit, that all images in one region to overlap. In these cases, it is conceivable that initially a (local) reconstruction deviation is performed only for the regions in which at least two reconstruction images overlap in a common region. Based on this information, i.e. the locally determined reconstruction deviations, the overall reconstruction deviation can be minimised as the sum of the local reconstruction deviations, and then the refractive indices can be determined and finally a (rectified) overall reconstruction image can be determined with all images (overlapping or not).

Additionally or alternatively, by that it may be possible to construct an overall objective function based on the reconstruction deviations of the individual regions (i.e. the region and the further regions) of the object. The overall objective function can be successively minimised for each of the plurality of layers of the object, such as has been described above, with an (iterative) optimisation method, such as a grid search method, a random search method or a gradient method, whereby the precision of the determinations (estimates) of the refractive indices can be further increased. Furthermore, in particular, the effects of noise effects that are locally limited to a region of the object on the determination of the refractive indices can be reduced.

Preferably, the angle between the first orientation and the second orientation has a value between 10° and 120°, in particular between 45° and 90°, preferably at least about 90°. Through this, a large parallax angle between the first and second images and thus between the corresponding reconstruction images can be achieved, whereby the reconstruction deviations can be better calculated.

In particular, an angle between the plurality of further orientations each has a value between 40° and 100°, in particular between 50° and 80°, preferably at least about 60°. In particular, the plurality of further orientations are distributed equidistantly over the entire angular range (for example, at least approximately 180° and/or 360°) of the measurement field. Through this, an improved angular resolution can be achieved.

For the two angular ranges mentioned in the preceding paragraphs, it preferably applies that the angle indicated in each case relates to a difference between two orientations in which no further orientation is (is) set or present within the scope of a measurement, i.e. it is preferably always the (angularly) next orientation. Thus, for example, if it is stated that an angle between the first orientation and the second orientation is (at least approximately) 90°, this is preferably intended to mean that no measurement takes place at an angle between 0 and 90°.

Generally, a measurement (or capturing) can be made in (or among) at least or exactly two, or at least or exactly three, or at least or exactly four, and/or at most or exactly 16, or at most or exactly eight, orientations.

Alternatively or additionally, a capturing (or measurement) in relation to several orientations can cover a capturing range of at least 90°, preferably at least 180°, possibly 270° or (at least approximately) 360°. Coverage in this sense means in particular a sum of the angles between a first orientation and the orientation closest to it (or second orientation) and its closest (in terms of angle) orientation. For example, a capturing region of 270° can be formed in that there is an angle of 40° between a first orientation and a second orientation, an angle of 80° between a second orientation and a third orientation, and an angle of 150° between a third orientation and a fourth orientation (or also in that there are four orientations, each of which has an angular separation of 90° from one another).

In embodiments the elongated object may for example be captured at a first direction and a second (exactly opposite or opposing) direction or orientation. In particular, an arrangement for capturing is selected such that the (elongated) object to be captured can be captured from all directions or in all orientations (i.e. a corresponding capturing possibility is at least present).

The object of the invention is further solved by a computer-readable medium comprising a plurality of instructions which, when executed by at least one processor, cause the processor to execute the method of the above type.

Furthermore, the object of the invention is solved by a device for rectifying images of an object, in particular of the above type, wherein the device shows the following:
at least one capturing unit which is designed to capture at least one region of the object, in particular by means of an optical coherence tomography method, in at least one first orientation in a first image and in at least one second, in particular different, orientation in a second image;
at least one computing unit which is connected to the capturing unit and is designed to
   generate, on the basis of the captured images, corresponding reconstruction images of the region, wherein at least one refractive index for each of a plurality of layers of the object is determined, preferably iteratively, on the basis of, in particular spatial, reconstruction deviations between the first and second reconstruction images; and
   calculate a rectified reconstruction image based on the determined refractive indices.

The device according to the invention has the advantages that were already described in relation to the method for rectifying images of an object.

The features described in connection with the method for rectifying images of an object and the advantages associated therewith are also combinable with the device according to the invention and can in particular be implemented as a corresponding configuration of the device, in particular of the computing unit.

The object of the invention is further solved by a system for rectifying images of an object, comprising a device of the above type, which is in particular designed to carry out the method according to the above type, as well as at least one elongated object.

Further embodiments will be apparent from the following disclosure.

### BRIEF DESCRIPTION OF THE DRAWINGS

In the following, the invention will be further explained by means of non-limiting example embodiments with reference to the accompanying drawings. Hereby show:

FIG. 1 a schematic representation of a single light beam incident on an object to be captured;

FIG. 2 a schematic representation of an example embodiment of the device according to the invention;

FIG. 3 a flow chart of an example embodiment of the method according to the invention;

FIG. 4A a schematic representation (image) of the individual beams (shown as straight lines) as delivered by an OCT measurement from the direction of the X-axis;

FIG. 4B a schematic representation (image) of the individual rays (shown as straight lines) as provided by an OCT measurement from the Y-axis direction;

FIG. 5A a reconstruction, starting from the image in FIG. 4A, of points from the X-axis direction with a refractive index of n₁=1.3 of a cross-section of an object to be captured;

FIG. 5B a reconstruction, starting from the image of FIG. 4B, of points from the Y-axis direction with a refractive index of n₁=1.3 of a cross-section of an object to be captured;

FIG. 5C a superposition of the reconstructions from the points from the X-axis and Y-axis direction with a refractive index of n₁=1.3 of a cross-section of an object to be captured;

FIG. 6A a reconstruction of points from the X-axis direction with a refractive index of n₁=1.7 of a cross-section of an object to be captured;

FIG. 6B a reconstruction of points from the Y-axis direction with a refractive index of n₁=1.7 of a cross-section of an object to be captured;

FIG. 6C a superposition of the reconstructions of points from the X-axis and Y-axis directions with a refractive index of n₁=1.7 of a cross-section of an object to be captured;

FIG. 7A a reconstruction of points from the X-axis direction with a refractive index of n₁=1.5 of a cross-section of an object to be captured;

FIG. 7B a reconstruction of points from the Y-axis direction with a refractive index of n₁=1.5 of a cross-section of an object to be captured;

FIG. 7C a superposition of the reconstructions of the points from the X-axis and Y-axis directions with a refractive index of n₁=1.5 of a cross-section of an object to be captured; and

FIG. 8 a schematic representation of a cross-section of an object to be captured.

### DETAILED DESCRIPTION OF THE INVENTION

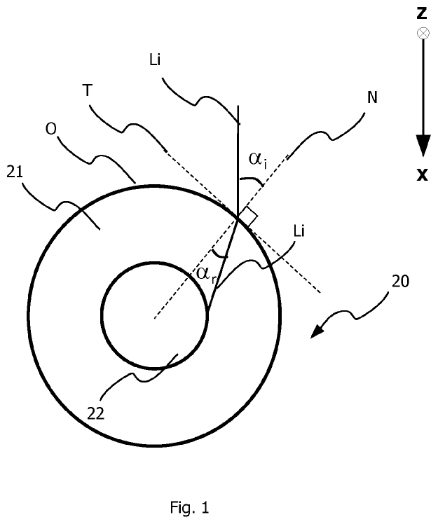

In FIG. 1 exemplary a measuring object 20 to be captured in a measuring field is shown. In the present example, the object 20 (in the Z-direction elongated extending) has at least essentially a round cross-sectional area and an outer layer 21 as well as an inner layer 22. Of course, any other cross-sectional shapes are also conceivable, such as oval, rectangular squared or polygonal.

In the present example embodiment, the object 20 may, for example, have a diameter of 0.5 mm to 10.0 mm, whereby the individual layer thicknesses of the object 20 may, for example, have a value that is less than 8.0 mm, preferably less than 5.0 mm.

In the illustrated example, a light beam Li impinges on the surface O of the object 20.

In FIG. 1, the incoming light beam Li is directed from the X axis direction onto the surface O of a measuring object 20 in the measuring field.

By an interpolation of the points on the surface O that are adjacent on both sides to the point of incidence, it is possible, for example, to determine the tangent T and from this the normal N at the point of incidence, which is at right angles to the tangent T.

The angle between the normal N and the light beam Li is the angle of incidence α_{i,0}. Here n₀ is the refractive index of the material outside the object (usually air). The refractive index n₁ is the refractive index of the first layer 21 of the object 20.

The angle of refraction α_{r,1} of the light beam Li inside the object 20 can then be calculated according to Snellius' law with the following equation:

n₀·sin(α_{i,0})=n₁·sin(α_{r,1}).

The light beam Li passes through the first layer 21 inside the object 20 until it is either reflected or refracted by the top surface of the next layer 22 or by a subsequent surface of another layer within the object 20. The distance travelled by the light beam Li inside the object 20 is referred to as the path length Δl.

The path length Δl that the light beam Li covers inside the object 20 can be determined by an OCT method. However, due to the reduced propagation speed of the light beam in the medium with refractive index n₁>n₀, in the present example the path length Δlm measured by the OCT method is longer than the actual path length Δlr between the surfaces of the layers 21, 22.

The actual path length Δlr between the outer and first inner layer 21, 22 of the object 20 can be determined by the OCT method using the measured path length Δlm by the following equation:

$$Δ lr = \frac{Δ l m}{{n}_{1}} {n}_{0} .$$

By measuring the path length Δlm of the light beam Li from a certain direction (from the X-axis direction) at different points of the outer surface O, a cross-section of the inner surface viewed from the X-direction can be reconstructed.

However, for the reconstruction, in addition to the measured path length Δlm, which is obtained by the OCT method, and the angle of incidence α_{i,0} of the light beam L, which can be determined from the OCT image, knowledge of the refractive index is also necessary. Since the refractive index n₁ is not known in advance, a fixed estimated value, which comes e.g. from laboratory measurements, is used in the prior art.

After determining the cross-section of the first inner layer 21, the subsequent inner layers (layer 22 in FIG. 1) can be reconstructed according to the procedure described above. The first inner layer 21 is now considered to be the outer layer.

By the optical device being designed so that all points of all layer boundaries are measured by at least one beam of an axis, the entire cross-section of the object can be reconstructed.

As mentioned above, in practice the refractive index n₁ of the materials in the measured object 20 is not known a priori. Without the indication of the refractive indices, it is not possible to reproduce (reconstruct) the cross-section of the measuring object 20 in the measuring field at least substantially without distortion.

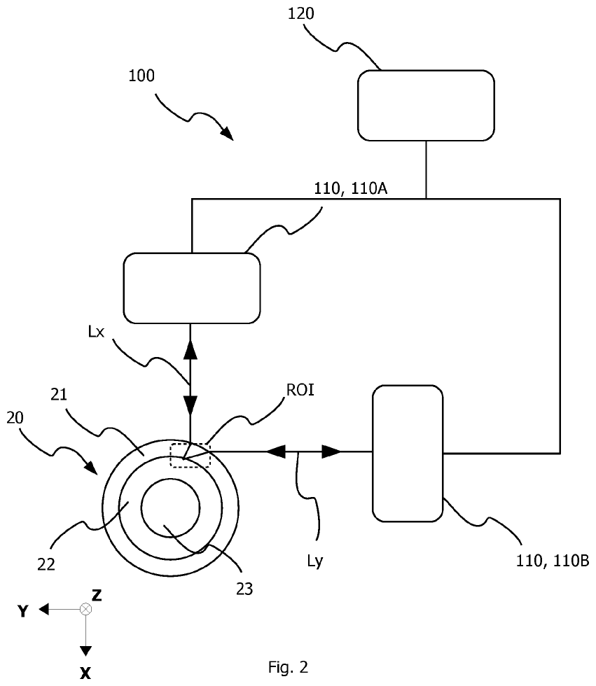

In FIG. 2 shows an embodiment example of a device 100 according to the invention for rectifying images of an elongated translucent object 20. The object 20 shown in FIG. 2 has three layers 21, 22 and 23.

The object 20 has an at least substantially round cross-section (in X and Y direction) and is formed elongated in the Z direction.

In addition, a region of interest (ROI) is shown with a dashed outline in FIG. 2. The device 100 comprises a capturing unit 110 configured to capture the object 20 according to an optical coherence tomography method in the X-direction in a first image and in the Y-direction in a second image. The incoming and reflected light beams Lx, Ly that can be emitted and received by the capturing unit 110 for capturing the region ROI are shown as double arrows in FIG. 2.

In FIG. 2, the capturing unit 110 consists of two capturing modules 110A and 110B that are aligned such that a region ROI of the object 20 is captured (approximately) simultaneously from different directions (orientations γ1 and γ2), i.e., the X-axis direction for capturing module 110A and the Y-axis direction for capturing module 110B. The angle between the capturing modules is 90° in the embodiment example. It is also possible that the capturing unit comprises a plurality of capturing modules (not shown).

Furthermore, a capturing unit 110 would be conceivable that comprises only one capturing module which can be rotated and/or displaced in such a way that the region ROI can be captured from multiple (different) directions.

Furthermore, in this embodiment example, the capturing unit 110 can be moved in such a way that further (possibly overlapping) regions of the object 20 can be captured.

The capturing unit 110 is communicatively connected to a computing unit 120. The computing unit 120 is configured to generate corresponding reconstruction images of the region ROI based on the captured images.

In this embodiment example, spatial reconstruction deviations between a plurality of points in the corresponding reconstruction images are now calculated. Based on the determined reconstruction deviations, a refractive index n₁, n₂ and n₃ is now determined for each layer 21, 22 and 23 of the object 20.

Using the determined refractive indices n₁, n₂ and n₃, an overall rectified reconstruction image is now calculated. The computing unit 120 may further comprise one or more storage units as well as one or more interfaces that enable the calculated refractive indices and/or the rectified overall reconstruction image to be stored and/or sent to further computing or processing units and/or displayed graphically or numerically (not shown).

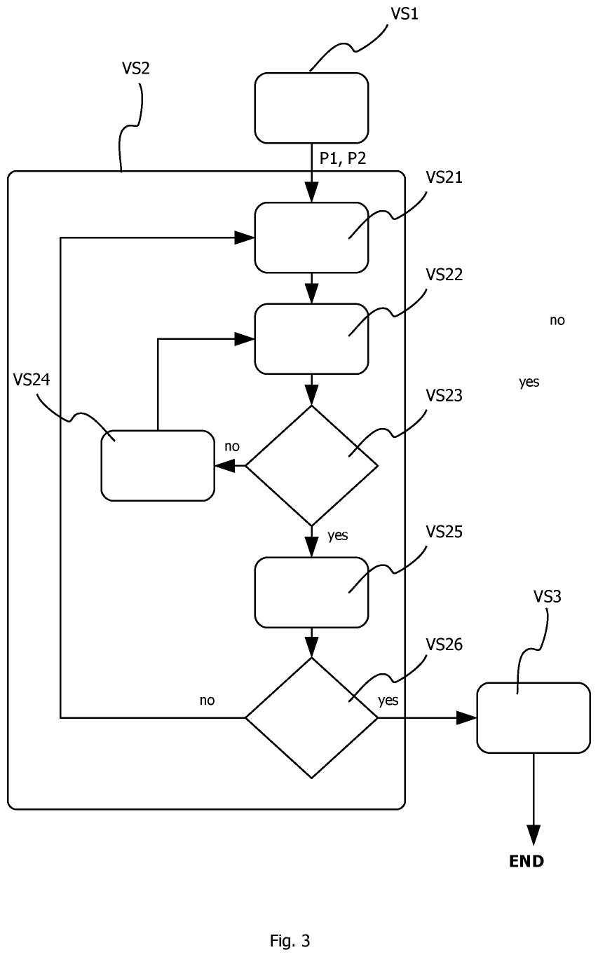

FIG. 3 shows a flowchart for an embodiment example of the method according to the invention for rectifying OCT images. The illustrated method comprises a capturing step VS1 in which a region ROI of the object 20 is captured from a first orientation γ1 and a second orientation γ2 in a first image P1 and a second image P2.

It is of course also possible that other regions of the object are captured in the capturing step VS1. In this case, the capturing unit may comprise a plurality of capturing modules, for example, as previously described. It would also be conceivable that the capturing unit and/or the object to be captured are rotated and/or displaced in such a way that further regions can be captured. Based on all captured images, which comprises the first and second images P1, P2 as well as the further images, a global refractive index for each layer is calculated in the determination step VS2, whereby an overall reconstruction image is determined from an overall reconstruction deviation, which is determined with information from all local images.

Based on the first and second images P1, P2, in the subsequent determination step VS2, in a sub-step SV21, corresponding reconstruction images R1, R2 with an initially set refractive index nᵢₙᵢₜ are generated from a first layer 21 of the object 20. In a further sub-step SV22, spatial reconstruction deviations between individual points in the two reconstruction images R1, R2 are calculated in this embodiment example.

In the present embodiment example, the reconstruction deviations are calculated using the Euclidean norm. Other (weighted) norms are also conceivable for the calculation of the spatial reconstruction deviations.

In sub-step VS23, at least one termination criterion is now queried. The termination criterion can be given, for example, by a threshold value for the objective function and/or an objective function change or a maximum number of steps.

If it is decided in sub-step VS23 that a minimum of the objective function with the current refractive index n_{current} has not yet been reached, a new refractive index n_{new,step} is determined for a further optimisation step in sub-step VS24. The procedure for determining a new refractive index n_{new,step} in sub-step VS24 depends on which optimisation method (gradient, grid search or random search method) is used. As already explained above, a new refractive index n_{new,step} can, for example, be determined on the basis of the first derivative of the objective function in the current parameter point (Steepest-Descent method) or on the basis of the first and the second derivative of the objective function in the current parameter point. In VS24, the corresponding reconstruction images are updated using the new refractive index n_{new,step}, whereby in sub-step VS22 reconstruction deviations are again calculated for the new refractive index n_{new,step}.

If it has been determined in sub-step VS23 that the objective function for the current refractive index n_{current} determined in the optimisation method is minimal according to the termination criterion described above, the current refractive index for the current layer is stored. In addition, the method is continued with a lower layer, as viewed from the surface O of the object 20.

VS25 represents one of several possible subsequent process steps. In particular, an overall reconstruction image may be created from the various local OCT images. In sub-step VS26, it is now queried whether the current layer is the last, preferably innermost, layer; if this is not the case, it is returned to step VS21 and, on the basis of an initial refractive index nᵢₙᵢₜ for the next layer, corresponding reconstruction images are generated for the next deeper layer.

Of course, preferably different, initial refractive indices can also be set individually for each layer, which are known for example from the previous measurement. Additionally or alternatively, the initial refractive indices can also be used from previous estimates of the refractive index.

If it has been determined in sub-step VS26 that the current layer is the last layer, in this embodiment example an rectified overall reconstruction image is calculated in rectification step VS3 using the refractive indices determined in determination step VS2, and subsequently the process is terminated.

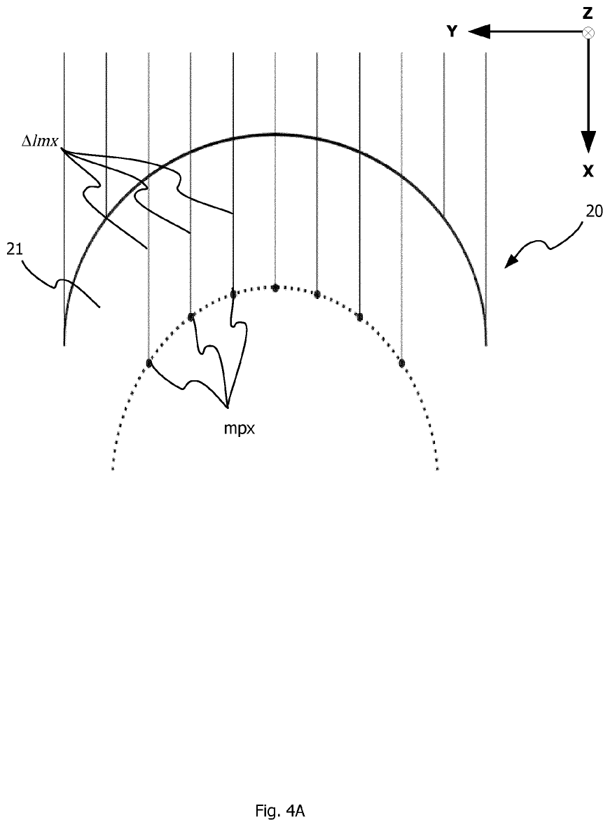

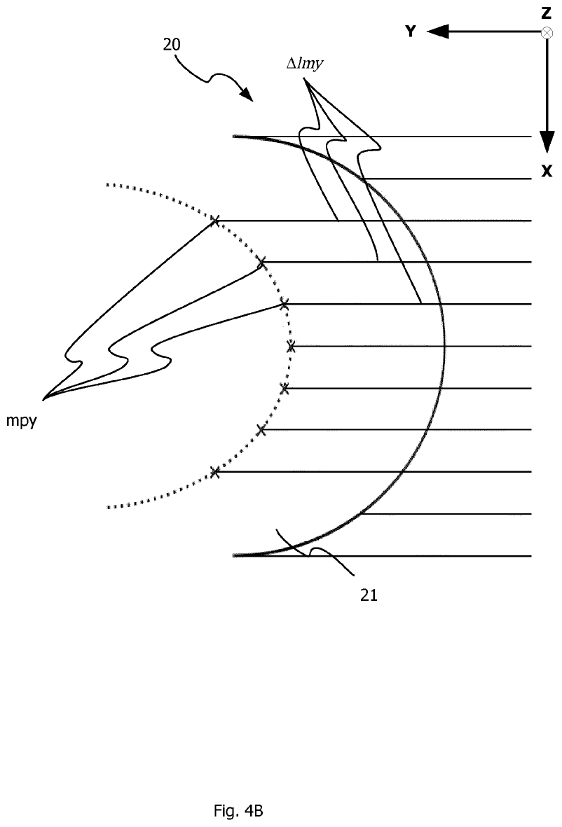

In FIGS. 4A to 7C individual process steps of the method according to the invention described above are exemplary shown.

In FIG. 4A, an OCT image with the cross-section of the object 20 to be captured with a layer 21 is shown. Furthermore, in FIG. 4A the measured path length Δlmx is drawn from the X-axis direction, which is shown in the image as a straight line. In addition, some measurement points mpx are exemplary shown in FIG. 4a.

FIG. 4B shows the OCT image with the cross-section of the object to be captured and the measured path length Δlmx from the Y-axis direction, which is also shown as a straight line in the image. In addition, some measuring points mpy are exemplary shown in FIG. 4b.

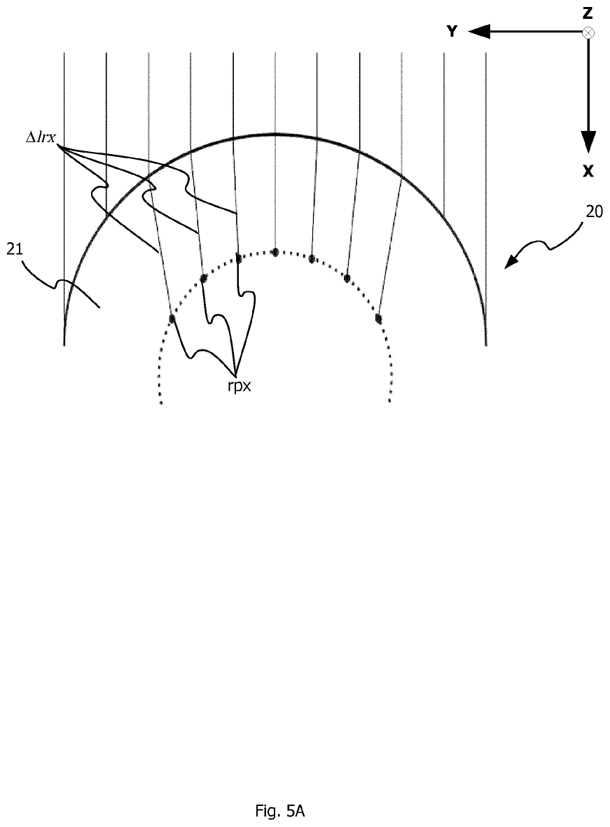

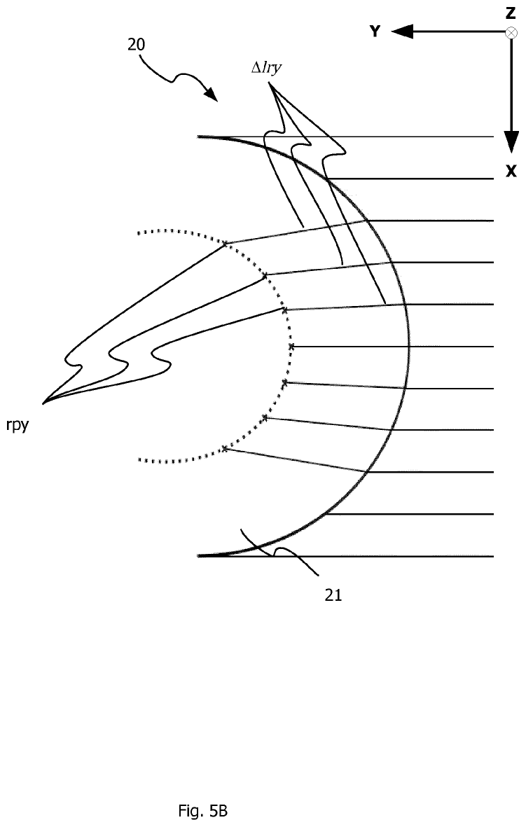

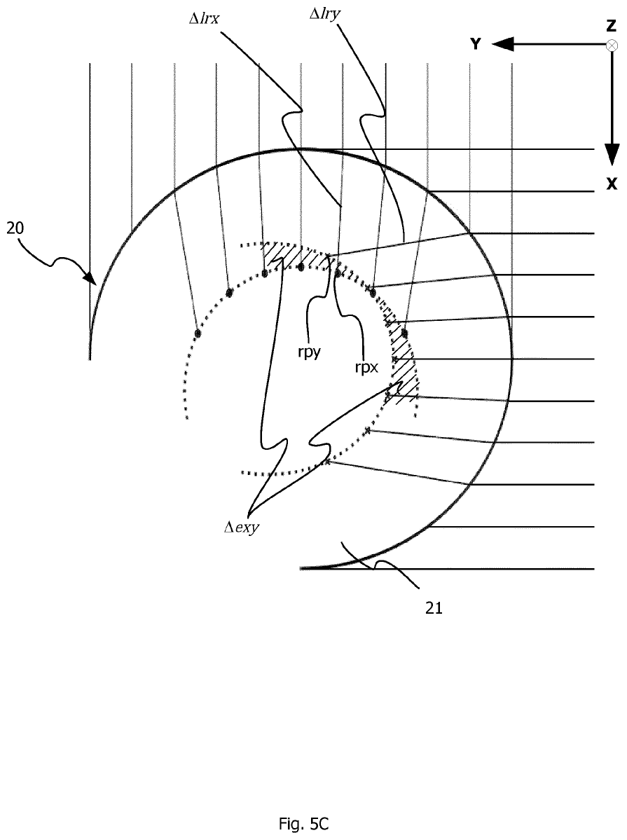

In FIG. 5A, a plurality of reconstructed points rpx in a measurement from the X-axis direction are shown, which are reconstructed by the device 100 when the material of the layer 21 of the object 20 has a refractive index of n₁=1.3. Visible is the estimated/reconstructed path length Δlrx and the direction of the refracted beam, which is obtained under the assumption of n₁=1.3. In FIG. 5B the plurality of reconstructed points rpy that can be reconstructed when measuring from the Y-axis direction are shown. Visible is the estimated path length Δlry and the direction of the refracted beam, which is obtained under the assumption of n₁=1.3.

FIG. 5C shows a superposition of the measurements shown in FIG. 5A and FIG. 5B. In addition, the spatial reconstruction deviations Δexy between the individual reconstructed points rpx and rpy are shown.

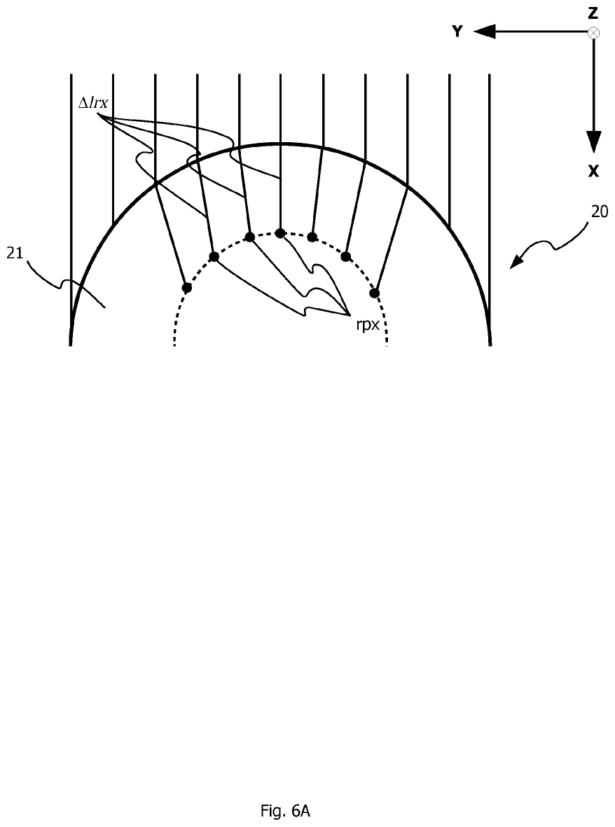

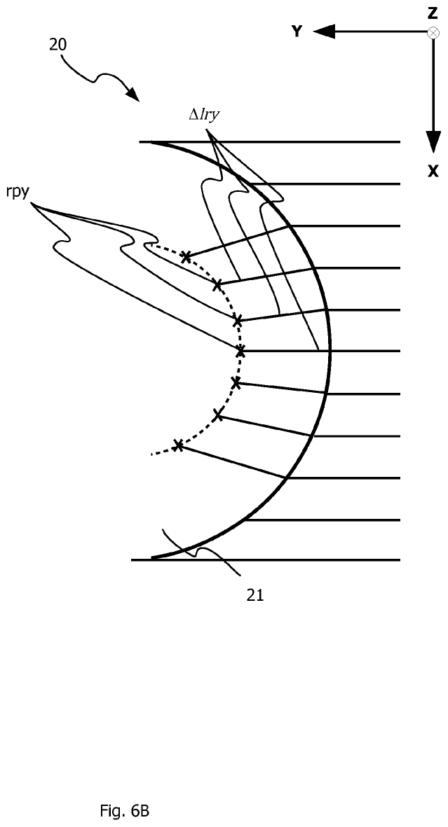

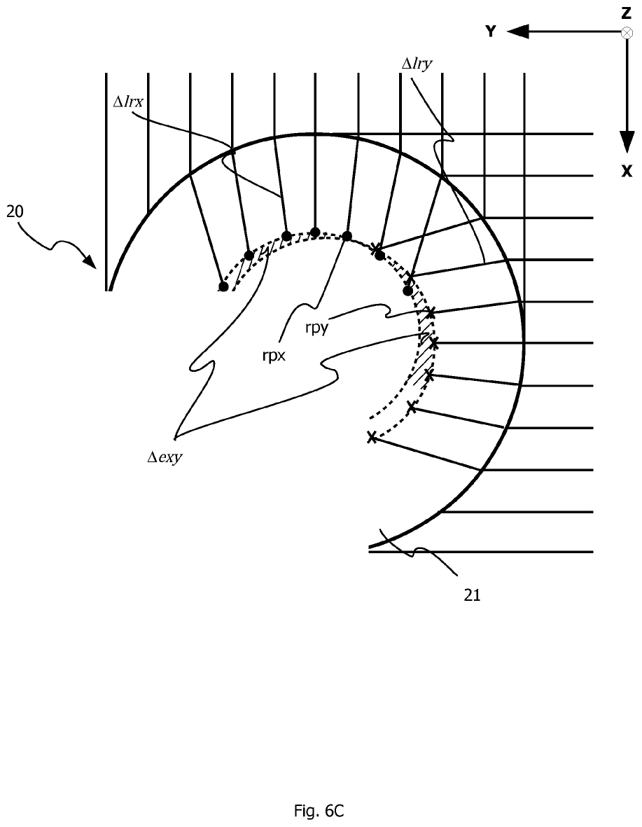

FIG. 6A shows another example of a plurality of reconstructed points rpx in the measurement of FIG. 4A of the imaged object 20 from the X-axis direction. The assumed refractive index of the material of layer 21 in this example is n₁=1.7. FIG. 6B shows a reconstruction starting from the measurement of FIG. 4B from the Y-axis direction.

FIG. 6C shows a corresponding superposition of the reconstructed points rpx and rpy. In addition, FIG. 6C shows the spatial reconstruction deviations Δexy between the individual reconstructed points rpx and rpy.

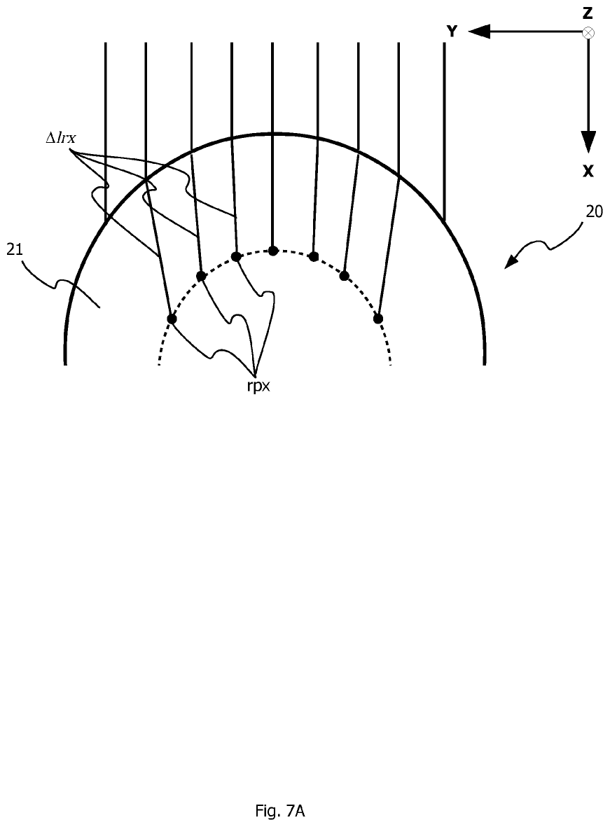

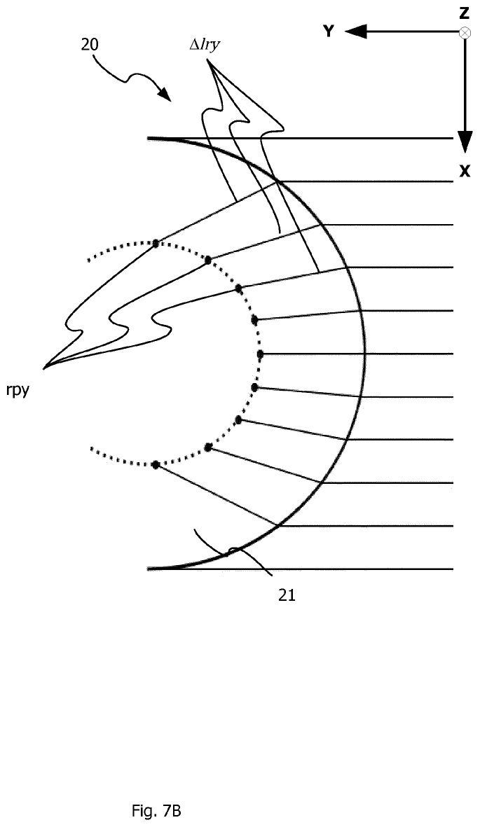

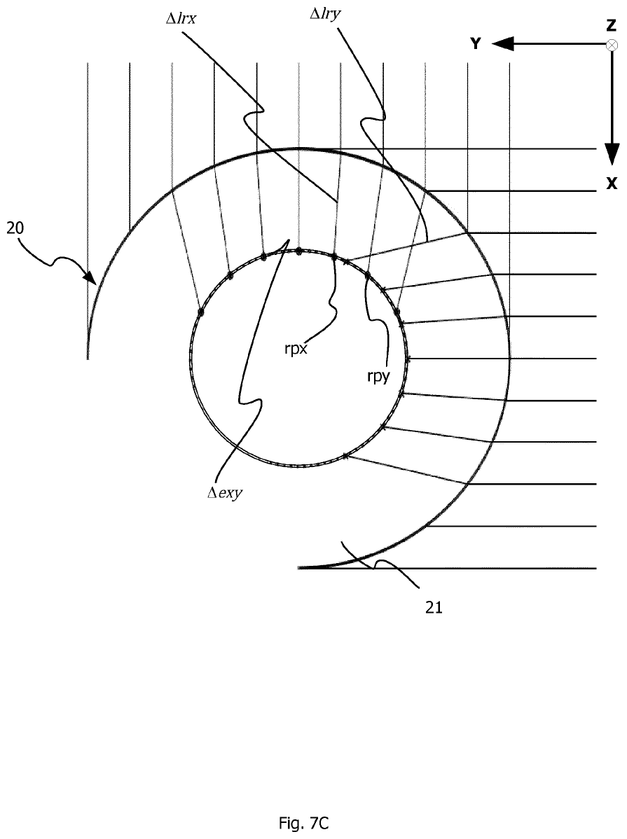

In FIGS. 7A to 7B, further reconstructed points rpx and rpy are shown individually which are reconstructed from the X-axis and Y-axis directions with a refractive index of n₁=1.5. FIG. 7C shows the corresponding superposition of the reconstructed points and the reconstruction deviations Δexy. The reconstruction deviations Δexy from FIG. 7C are the smallest in total compared to the reconstruction deviations shown in FIGS. 5C and 6C. The method would thus determine a refractive index of n₁=1.5 for the material of the layer 21 of the object 20.

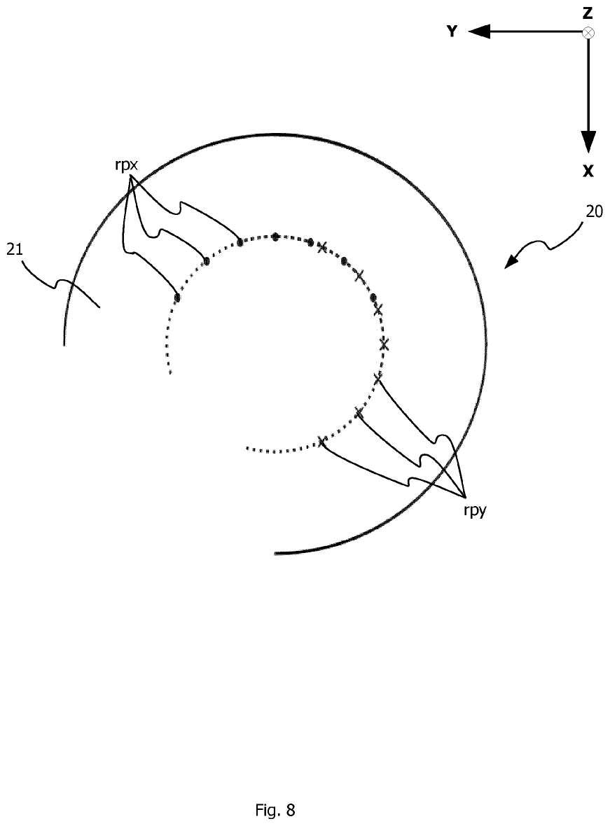

FIG. 8 shows a cross-section of the object 20 to be captured. The object 20 in FIG. 8 has a layer 21 with a homogeneously distributed refractive index n₁. In addition, the object has a hollow region in the centre. In the embodiment example illustrated in FIG. 8, the object 20 is a tube. The object 20 is measured with a two-axis optical device 100, wherein the two axes (in the X and Y directions) along which the object is measured are perpendicular to each other.

Further, in FIG. 8, as a consequence of the results of FIG. 7C, the regions of the outer and inner surfaces are shown that can be measured with the two-axis optical device 100, where both reconstructed points rpx measured from the X-axis direction and reconstructed points rpy measured from the Y-axis direction are shown. Together with reconstructed points from OCT images from further directions, an overall reconstruction image can thus be determined.

### LIST OF REFERENCE SIGNS

20 object to be captured
21 first (outermost) layer of the object
22, 23 further (further inwards) layers of the object
100 device for rectifying images of an object
110 capturing unit
110A, 110B individual capturing modules of the capturing unit
n₁, n₂, n₃ refractive indices of the individual layers of the object
nₙᵢₜ initial refractive index (for the layer to be measured)
n_{new,step} new refractive index for the next optimisation step
n_{current} current refractive index
mpx a plurality of measuring points determined from the X-direction
mpy a plurality of measuring points determined from the Y-direction
rpx a plurality of points reconstructed from the X-direction
rpy a plurality of points reconstructed from the Y-direction
N normal
Li incoming light beam
P1 first image
P2 second image
R1, R2 corresponding reconstruction images
ROI region of the object (region-of-interest)
T tangent
VS1 capturing step
VS2 determination step
VS21 . . . VS26 sub-steps of the determination step
VS3 rectification step
X, Y, Z X-, Y- and Z-axis
γ1 first orientation
γ2 second orientation
Δexy reconstruction deviation(s)
Δlrx actual/reconstructed path length(s) in X direction
Δlry actual/reconstructed path length(s) in Y-direction
Δlmx measured path length(s) in the X-direction from an OCT image
Δlmy measured path length(s) in the Y-direction from an OCT image.

1-20. (canceled)

21. A method for rectifying images of an elongated object generated in particular by means of an optical coherence tomography method, wherein the method comprises the following steps:
a) a capturing step in which at least one region of the object is captured in at least one first orientation (γ1) in a first image and in at least one second, different orientation (γ2) in a second image, by means of an optical coherence tomography method; as well as
b) a determination step, wherein corresponding reconstruction images of the region are generated on the basis of the captured images,
wherein at least one refractive index (n₁, n₂, n₃) is determined iteratively for each of a plurality of layers of the object on the basis of spatial reconstruction deviations (Δexy) between the first and second reconstruction images, and
c) a rectification step, wherein a rectified overall reconstruction image is calculated on the basis of the determined refractive indices (n1, n2, n3).

22. The method according to claim 21,
wherein the capturing step and/or the determination step are each done periodically repeatedly or event-controlled, wherein an execution rate of the capturing step differs from an execution rate of the determination step, provided that both steps are done periodically repeatedly.

23. The method according to claim 21,
wherein for each of the layers of the object the at least one refractive index (n1, n2, n3) is determined with an optimisation method, in which an objective function calculated from the spatial reconstruction deviations (Δexy) is minimised.

24. The method according to claim 23,
wherein the objective function calculated from the spatial reconstruction deviations (Δexy) is a multi-dimensional objective function for which a set of refractive indices (n1, n2, n3) for the layers of the object, which minimises the multi-dimensional objective function, is determined by the optimisation method.

25. The method according to claim 21,
wherein first the at least one refractive index (n1) of the first layer adjacent to a surface of the object is determined with an optimisation method.

26. The method according to claim 25,
wherein the at least one refractive index (n1, n2, n3), starting from the first layer, is successively determined for each further layer, which in particular adjoins the first layer or a respective preceding layer, using an optimisation method.

27. The method according to claim 23,
wherein the spatial reconstruction deviations (Δexy) are calculated by determining the spatial distances between a plurality of points (rpx) of an interface of a layer, the positions of which are calculated on the basis of the first reconstruction image, with a plurality of points (rpy) of the interface of the layer, the positions of which are calculated on the basis of the second reconstruction image and/or at least one further reconstruction image, wherein the objective function is calculated in particular as the sum of the spatial distances.

28. The method according to claim 27,
wherein the objective function is calculated as the sum of the squares of the spatial distances.

29. The method according to claim 23,
wherein the at least one refractive index (n1, n2, n3) for each of the layers is determined with a grid search method that minimizes the objective function.

30. The method according to claim 23,
wherein the at least one refractive index (n1, n2, n3) for each of the layers is determined with a random search method, wherein a refractive index (n1, n2, n3) is selected from a set of predetermined refractive indices such that the objective function is minimized.

31. The method according to claim 23,
wherein the at least one refractive index (n1, n2, n3) for each of the layers is determined with a gradient method that minimizes the objective function.

32. The method according to claim 21,
wherein in the capturing step the region is acquired in a plurality of further, different, orientations in a plurality of further images.

33. The method according to claim 32,
wherein in the determination step a plurality of corresponding reconstruction images of the region is generated, and the refractive indices (n1, n2, n3) are iteratively determined on the basis of spatial reconstruction deviations (Δexy) between the plurality of corresponding reconstruction images.

34. The method according to claim 21,
wherein the capturing step is carried out for one or a plurality of further, at least partially overlapping, regions of the object,
wherein each of the further regions of the object is captured from at least two different orientations (γ1,γ2), and
wherein in the determination step for each region of the object that is captured from at least two orientations (γ1,γ2) the refractive indices (n1, n2, n3) of the materials of the layers of the object are determined.

35. The method according to claim 21,
wherein an angle between the first orientation (γ1) and the second orientation (γ2) is a value between 10° and 120°.

36. The method according to claim 32,
wherein an angle between said plurality of further orientations each has a value between 40° and 100°.

37. The method according to claim 21,
wherein the elongated object has a length which is at least 10 times as great as a width and/or
is hollow on the inside at least in sections and/or
has no cavity at least in sections and/or
has several layers, in particular with different materials, preferably with different refractive indices, and/or
comprises a single- or multi-layer tube, or a single- or multi-layer hose, or a single- or multi-layer cable, or a single- or multi-layer wire, or a single- or multi-layer catheter.

38. A computer-readable medium comprising a plurality of instructions which, when executed by at least one processor, cause the processor to perform the method of claim 21.

39. A device for rectifying images of an object, according to the method of claim 21,
wherein the device comprises the following:
at least one capturing unit which is designed to capture at least one region of the object, by means of an optical coherence tomography method, in at least one first orientation (γ1) in a first image and in at least one second, in particular different, orientation (γ2) in a second image;
at least one computing unit which is connected to the capturing unit and is designed to
generate, on the basis of the captured images, corresponding reconstruction images of the region,
wherein at least one refractive index (n1, n2, n3) for each of a plurality of layers of the object is determined iteratively on the basis of spatial, reconstruction deviations (Δrp1, Δrp2, Δrp3) between the first and second reconstruction images; as well as
calculate a rectified overall reconstruction image based on the determined refractive indices (n1, n2, n3).

40. A system for rectifying images of an object, comprising a device according to claim 39, in particular designed to perform said method, as well as at least one elongated object.
